(19) United States
(12) Patent Application Publication
(10) Pub. No.: US 2020/0174310 A1
(43) Pub. Date: Jun. 4, 2020

(54) LIQUID CRYSTAL DISPLAY DEVICE

(71) Applicant: HON HAI PRECISION INDUSTRY CO., LTD., New Taipei (TW)

(72) Inventors: CHUN-YUN PAN, New Taipei (TW); CHIEN-YU WEI, New Taipei (TW); WEN-CHIN LO, New Taipei (TW); SIN-TUNG HUANG, New Taipei (TW); TA-CHIEN CHEN, New Taipei (TW)

(21) Appl. No.: 16/654,881

(22) Filed: Oct. 16, 2019

Related U.S. Application Data
(60) Provisional application No. 62/774,525, filed on Dec. 3, 2018.

(51) Int. Cl. G02F 1/1335; F21V 8/00; G02F 1/1333

(52) U.S. Cl. CPC G02F 1/133512; G02F 1/133528; G02F 1/1368; G02F 1/133308; G02B 6/0081

(57) ABSTRACT

A liquid crystal display device proofed against light leaking from a join between backlight module and display panel also has a camera. The display device defines a display area surrounding a light transmission area which allows external light to enter the camera. The backlight module defines a mounting hole corresponding to the light transmission area, the camera being in the mounting hole. Black foam is arranged at the join of the display panel and the backlight module, the black foam has light absorbing properties.

### FIELD

The subject matter herein generally relates to display devices.

### BACKGROUND

A liquid crystal display device generally includes a backlight module and a display panel stacked on the backlight module. However, light of the backlight module can leak through the joint area where the backlight module and the display panel are joined.

Therefore, there is room for improvement in the art.

### BRIEF DESCRIPTION OF THE DRAWINGS

Implementations of the present disclosure will now be described, by way of embodiment, with reference to the attached figures.

FIG. 1 is a front view showing an embodiment of a liquid crystal display device.

FIG. 2 is a back view of the liquid crystal display device of FIG. 1.

FIG. 3 is a cross-sectional view taken along line III-III of FIG. 2

FIG. 4 is a cross-sectional view taken along line IV-IV of FIG. 2

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electrical elements, such as capacitors, resistors, amplifiers, and the like.

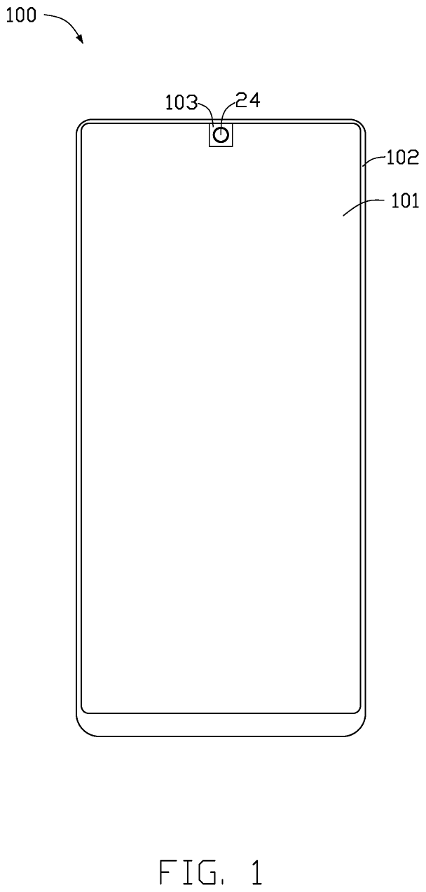

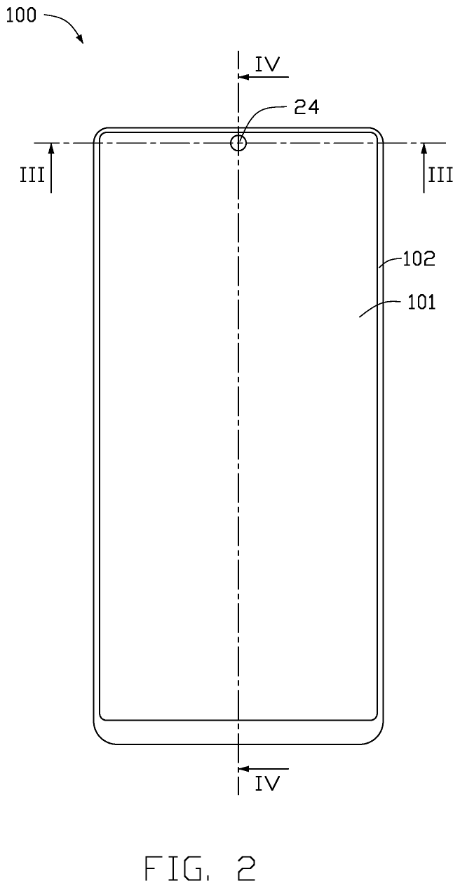

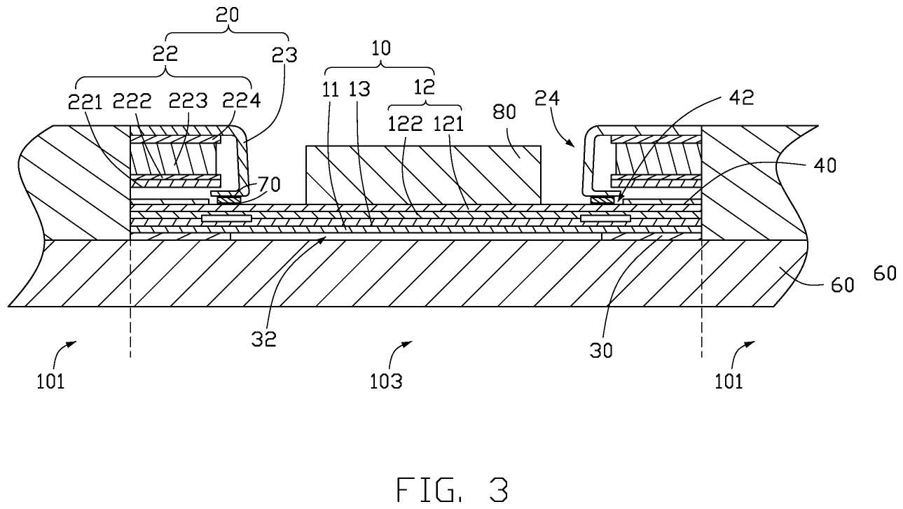

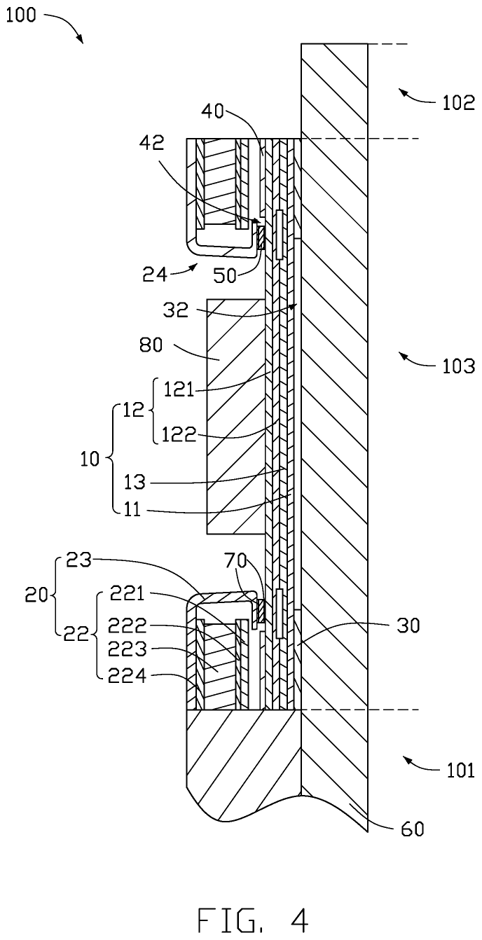

As shown in FIGS. 1 and 2, a liquid crystal display device 100 defines a display area 101, a border area 102 surrounding the display area 101, and a light transmission area 103 surrounded by the display area 101. The light transmission area 103 allows extraneous light to enter a lens of a camera 80 (labelled in FIGS. 3 and 4) of the liquid crystal display device 100. In one embodiment, the light transmission area 103 is circular, and the light transmission area 103 is at an intermediate width of the display area 101. In other embodiments, the light transmission area 103 may have other shapes, and may be located at other positions of the display area 101.

As shown in FIGS. 3 and 4, the liquid crystal display device 100 includes a display panel 10 on top and a backlight module 20 below. The display panel 10 is on a light exit side of the backlight module 20. The display panel 10 includes an array substrate 12, a color filter substrate 11 opposite to the array substrate 12, and a liquid crystal layer 13 between the array substrate 12 and the color filter substrate 11. The color filter substrate 11 may include a transparent first substrate (not shown), a black matrix (not shown) on a side of the first substrate near the liquid crystal layer 13, a filter layer (not shown), a protective layer (not shown), and so on. The array substrate 12 includes a transparent second substrate 121 and a thin film transistor layer 122 on a side of the second substrate 121 adjacent to the liquid crystal layer 13. The thin film transistor layer 122 includes, for example, a gate electrode layer, a gate insulating layer, an active layer, a source and drain electrode layer, and the like. Pixel electrodes (not shown) and common electrodes (not shown) are also provided in the display area 101. In one embodiment, the pixel electrodes and the common electrodes are in the display area 101 and rotate the liquid crystal molecules in the liquid crystal layer 13 to form images for display.

The backlight module 20 may be a direct type backlight module or an edge type backlight module. The backlight module 20 includes a light source (not shown), an optical film group 22, and a back plate 23 (e.g., made of a metal material). The optical film group 22 includes a brightness enhancement film 221, a diffusion sheet 222, a light guide plate 223, and a reflection sheet 224 sequentially stacked as stated in a direction away from the display panel 10. The backlight module 20 defines a mounting hole 24 extending through the backlight module 20 in the light transmission area 103. The mounting hole 24 is circular, and a size of the mounting hole 24 is larger than or substantially equal to a size of the light transmission area 103. The camera 80 is in the mounting hole 24. The back plate 23 is shaped to define an inner wall of the mounting hole 24 extending to abut against a surface of the array substrate 12. Since the camera 80 is in the display area 101, a screen ratio of the liquid crystal display device 100 is greater as compared to conventional art, in which the camera 80 is outside the display area.

As shown in FIGS. 3 and 4, the liquid crystal display device 100 further includes a cover plate 60, a first polarizer 30, and a second polarizer 40. The first polarizer 30 is on a side of the color filter substrate 11 away from the array substrate 12. The cover plate 60 is on a side of the first polarizer 30 away from the color filter substrate 11. The second polarizer 40 is on a side of the array substrate 12 away from the color filter substrate 11 and is bonded to the brightness enhancement film 221 of the backlight module 20. The axes of the first and second polarizers 30 and 40 are perpendicular to each other. In the light transmission area 103, the first polarizer 30 defines a first light-passing hole 32 and the second polarizer 40 defines a second light-passing hole 42, holes 32 and 42 being symmetrically aligned. The arrangement is such that the first polarizer 30 and the second polarizer 40 do not shield the mounting hole 24. In addition, the cover plate 60 and the first polarizer 30 can be bonded together by a transparent optical adhesive. The transparent optical adhesive may be applied only between the surfaces of the first polarizer 30 and the cover plate 60. In other embodiments, when the transparent optical adhesive is pasted between the cover plate 60 and the first polarizer 30, the transparent optical adhesive may infill the first light-passing hole 32.

A junction between the backlight module 20 and the display panel 10, that is to say the junction between the back plate 23 and the array substrate 12, is provided with black foam 50. The black foam 50 is in the shape of a ring to surround the mounting hole 24. The top and bottom sides of the black foam 50 can be attached to the back plate 23 and the array substrate 12 respectively through a double-sided tape 70. In one embodiment, a thickness of the black foam 50 is approximately 0.3 mm when the black foam 50 is uncompressed and is approximately 0.2 mm when the black foam 50 is compressed. In other embodiments, the thickness, compressibility, and other features of the black foam 50 can be selected according to actual needs.

In one embodiment, the black foam 50 has light absorbing property, preventing the light of the backlight module 20 from leaking out from the area where the display panel 10 and the backlight module 20 are combined, thereby solving the light leakage problem. In addition, during mechanical reliability testing after the display panel 10 and the backlight module 20 are assembled, the black foam 50 serves as a link and a buffer preventing separation of the display panel 10 from the backlight module 20 and preventing cracking and failure of the second substrate 121 (which is made of glass). In addition, the black foam 50 is stable, with good appearance, and, with positional precision during manufacture, allows some toleration for dimensional differences of other materials. The foam 50 is also low cost.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A liquid crystal display device, comprising:
a backlight module comprising a light exit side;
a display panel on the light exit side of the backlight module;
a camera,
wherein the liquid crystal display device defines a display area for displaying images and a light transmission area surrounded by the display area, the light transmission area is configured for external light to enter the camera,
the backlight module defines a mounting hole extends through the backlight module in the light transmission area, and the camera is in the mounting hole; and
a black foam at a junction of the display panel and the backlight module, the black foam being ring shaped and surrounding the mounting hole.

2. The liquid crystal display device according to claim 1, wherein the backlight module comprises a back plate, and the back plate extends in a thickness direction of the liquid crystal display device to define an inner wall of the mounting hole.

3. The liquid crystal display device of claim 2, wherein the backlight module further comprises an optical film group, the optical film group comprises a brightness enhancement film, a diffusion sheet, a light guide plate, and a reflection sheet which are sequentially stacked as stated in a direction away from the display panel.

4. The liquid crystal display device according to claim 3, wherein the display panel comprises an array substrate adjacent to the backlight module, a color filter substrate opposite to the array substrate and a liquid crystal layer between the array substrate and the color filter substrate, the black foam is between the back plate and the array substrate.

5. The liquid crystal display device according to claim 4, wherein the black foam has a first side and a second side opposite to the first side, and each of the first side and the second side is attached to the back plate and the array substrate by a double-sided tape.

6. The liquid crystal display device according to claim 5, wherein a thickness of the black foam is 0.3 mm when the black foam is uncompressed and 0.2 mm when the black foam is compressed.

7. The liquid crystal display device according to claim 6, wherein the array substrate comprises a transparent second substrate and a thin film transistor layer on a side of the second substrate adjacent to the liquid crystal layer.

8. The liquid crystal display device according to claim 4, further comprising a first polarizer on a side of the color filter substrate away from the array substrate, and a second polarizer on a side of the array substrate away from the color filter substrate, wherein the first polarizer defines a first light through hole corresponding to the light transmission area, the second polarizer defines a second light-passing hole corresponding to the light transmission area, and a direction of the light-transmitting axis of the second polarizer and a direction of the light-transmitting axis of the first polarizer are perpendicular to each other.

9. The liquid crystal display device according to claim 8, further comprising a cover plate, wherein the cover plate is on a side of the first polarizer away from the color filter substrate.

10. The liquid crystal display device according to claim 9, wherein the cover plate and the first polarizer are bonded together by a transparent optical adhesive.
